(19) United States
(12) Patent Application Publication
(10) Pub. No.: US 2018/0259224 A1
(43) Pub. Date: Sep. 13, 2018

(54) SOLAR THERMAL COLLECTOR

(71) Applicant: SOLAR-O-MATIC TECHNOLOGIE INC., STE-HYACINTHE (CA)

(72) Inventors: Jean-Marc ROCHEFORT, STE-HYACINTHE (CA); Jocelyn CAUX, LA POCATIERE (CA)

(21) Appl. No.: 15/755,365

(22) PCT Filed: Aug. 25, 2016
(86) PCT No.: PCT/CA2016/051000

§ 371 Date: Feb. 26, 2018

Related U.S. Application Data
(60) Provisional application No. 62/209,977, filed on Aug. 26, 2015.

(51) Int. Cl. F24S 10/40; F24S 10/50; F24S 10/55

(52) U.S. Cl. CPC F24S 10/40; F24S 10/55; F24S 10/502

(57) ABSTRACT

A solar thermal collector for heating a fluid with absorbed solar thermal energy from solar radiations is provided. The solar thermal collector comprises an inlet configured to supply the fluid into the solar thermal collector, an outlet configured to evacuate the fluid from the solar thermal collector, and a solar absorber having an absorber plate and a base plate. The absorber plate has an absorber plate perimeter and an absorbing surface configured for absorbing the solar thermal energy from solar radiations. The base plate is connected to the absorber plate along the entire absorber plate perimeter so as to define a sealed cavity. The base plate and the absorber plate are connected at a plurality of contact points distributed so as to create an array of junctures across the sealed cavity, thereby allowing the fluid to circulate throughout the sealed cavity when flowing from the inlet to the outlet.

### TECHNICAL FIELD

The technical field generally relates to solar thermal energy, and more particularly relates to a non-concentrating solar thermal collector.

### BACKGROUND

Solar thermal energy (STE) relates to usable thermal energy which was generated through collection of solar radiations (also referred to as sunlight). STE-related equipment for collecting such solar radiations includes solar thermal collectors. A typical solar thermal collector is configured to include a collection area for collecting the solar radiations and an absorption area for absorbing the collected solar radiations.

Solar thermal collectors are either non-concentrating or concentrating. Non-concentrating solar thermal collectors are designed such that the collection area is substantially the same as the absorption area. Some known non-concentrating solar thermal collectors include absorber plates made of heat-conductive material so as to transfer the absorbed heat to a heat-transport fluid, which is passing through pipes attached to the absorber plates. The absorber plates are typically made of metal and can be painted with specific coatings, including black paint, to improve or maximize the heat retained by the absorber plates.

A non-concentrating solar thermal collector generally also includes a cover or casing which reduces heat losses while enabling the solar radiations to reach the internal absorber plate. A heat-insulating backing may be further provided to the non-exposed side of the absorber plate to further reduce the heat losses.

Selection of structural configurations and materials can greatly affect the solar thermal performance or the reliability when operating under varying meteorological conditions. There is thus still a need for an improved solar thermal collector.

### SUMMARY

In accordance with one aspect, there is provided a solar thermal collector for heating a fluid with absorbed solar thermal energy from solar radiations.

In some embodiments, the solar thermal collector generally comprises an inlet, an outlet and a solar absorber.

The inlet is configured to supply the fluid into the solar thermal collector. The outlet is configured to evacuate the fluid from the solar thermal collector. The solar absorber has an absorber plate and a base plate. The absorber plate has an absorber plate perimeter and an absorbing surface and is configured for absorbing the solar thermal energy from solar radiations. The base plate is connected to the absorber plate along the entire absorber plate perimeter so as to define a sealed cavity. The base plate and absorber plate are further connected at a plurality of contact points distributed so as to create an array of junctures across the sealed cavity, which allows the fluid to circulate throughout the sealed cavity when flowing from the inlet to the outlet.

In an embodiment, the contact points are evenly distributed along the absorbing surface.

In an embodiment, the array of junctures defines a juncture density selected within a range between about 100 junctures/m² and 300 junctures/m².

In an embodiment, the solar thermal collector further comprises at least one absorbing protuberance mounted to the absorbing surface.

In an embodiment, each of the at least one absorbing protuberance consists of a longitudinal bar. The longitudinal bar has an L-shaped cross-section and has a contact portion mounted on the absorber plate. The longitudinal bar is projecting from the contact portion and is extending outwardly from the absorber plate so as to offer an extended absorbing surface to solar radiations.

In an embodiment, a solar thermal assembly comprises the solar thermal collector and further comprises a heat-insulating casing for enclosing the solar absorber. The heat-insulating casing has a cover made from an optically transparent material and is spaced-apart from the absorber plate.

In an embodiment, the inlet and the outlet are located at diagonally opposed corners of the base plate.

In an embodiment, the inlet and the outlet are maximally spaced-apart.

Implementations of the present invention relate to a solar thermal collector making use of an improved fluid circulation path for heating a fluid with thermal energy absorbed from solar radiations.

In one aspect, there is provided a solar thermal collector including a solar absorber for absorbing solar radiations. The solar absorber includes an absorber plate and a base plate which are connected to each other along a perimeter thereof so as to define a sealed cavity being configured for receiving therein a fluid to be heated. The absorber plate and the base plate are further connected to each other at plurality of contact points distributed across opposed faces of the connected plates. The plurality of contact points thereby define a fluid circulation path within the sealed cavity for heating the fluid with thermal energy absorbed from solar radiations. The solar thermal collector also includes an inlet configured to supply the fluid to be heated into the sealed cavity; and an outlet configured to evacuate the fluid from the sealed cavity after circulation and heating thereof along the fluid circulation path.

In another aspect, there is provided a solar thermal collector assembly including the solar absorber as defined herein; and a heat-insulating casing configured to enclose the solar absorber. The heat-insulating casing includes a solar glass cover, which is spaced-apart from the absorber plate so as to expose an absorbing surface thereof to the solar radiations.

In another aspect, there is provided a solar absorber component for use in combination with the solar thermal collector or assembly as defined herein, the solar absorber component being distributed across an external surface of the absorber plate, and having a geometry selected to increase the absorbing surface of the solar absorber.

While the invention will be further described in conjunction with example embodiments, it will be understood that it is not intended to limit the scope of the invention to such embodiments. On the contrary, it is intended to cover all alternatives, modifications and equivalents as may be included as defined by the present description. The objects, advantages and other features of the present invention will become more apparent and be better understood upon reading of the following non-restrictive description of the invention, given with reference to the accompanying drawings.

### BRIEF DESCRIPTION OF THE DRAWINGS

FIG. 1 is schematic top view of a solar absorber from a solar thermal collector according to one embodiment of the present invention.

FIG. 2 is cross-sectional view of a portion of the solar absorber of FIG. 1 along line II.

FIG. 3 is a schematic side view of a solar absorber according to one embodiment of the present invention.

FIG. 4 is a close-up view of portion IV of FIG. 3.

FIG. 5 is a schematic top view of a solar absorber according to another embodiment of the present invention.

FIG. 6 is a close-up perspective view of portion VI of FIG. 5.

FIG. 7 is a perspective view of a solar thermal collector including a heat-insulating casing according to one embodiment of the present invention

FIG. 8 is a schematic perspective view of a casing base of a solar thermal collector according to one embodiment of the present invention.

FIG. 9 is a close-up view of portion IX of FIG. 8.

FIG. 10 is an exploded top perspective view of a solar thermal collector according to another embodiment of the present invention.

FIG. 11 is a close-up view of portion XI of FIG. 10.

FIG. 12 is a schematic side view of a solar thermal assembly according to one embodiment.

FIG. 13 is a side view of a support device according to one embodiment.

FIG. 14 is a close-up perspective view of the support device of FIG. 13.

### DETAILED DESCRIPTION

In the following description, similar features in the drawings have been given similar reference numerals. In order to not unduly encumber the figures, some elements may not be indicated on some figures if they were already mentioned in preceding figures. It should also be understood herein that the elements of the drawings are not necessarily drawn to scale and that the emphasis is instead being placed upon clearly illustrating the elements and structures of the present embodiments.

It should be understood that the terms “solar radiations” and “sunlight” are intended to refer to the total spectrum of electromagnetic radiations emanating from the Sun and reaching the Earth. Solar radiations may include radiations with a wavelength ranging from about 280 to 2500 nm, extending across the ultraviolet, visible and infrared portions of the electromagnetic spectrum. Of course, this range of wavelengths is presented only as being typical of solar radiations reaching the Earth and should not be construed as limiting.

In accordance with embodiments, there is provided a solar thermal collector for heating a fluid with absorbed solar thermal energy from solar radiations. It will be readily understood that such collectors may be used in conjunction with heating systems using a heated fluid as a source of thermal energy, such as for example heat exchanger systems and water heater. Some embodiments of the present invention may be useful in solar thermal energy applications where it is desirable to provide a solar thermal collector having a simplified design in comparison to known collectors, while maintaining a high thermal efficiency for heating a fluid with solar radiations. In one embodiment, the solar thermal collector may be used in residential applications, for heating a residence. Alternatively, the solar thermal collector may be used for heating commercial buildings.

It should be understood that the solar thermal collector according to embodiments can be installed at any locations benefiting from sunlight exposure, including on building roofs or walls, with attachment means that are known to one skilled in the art.

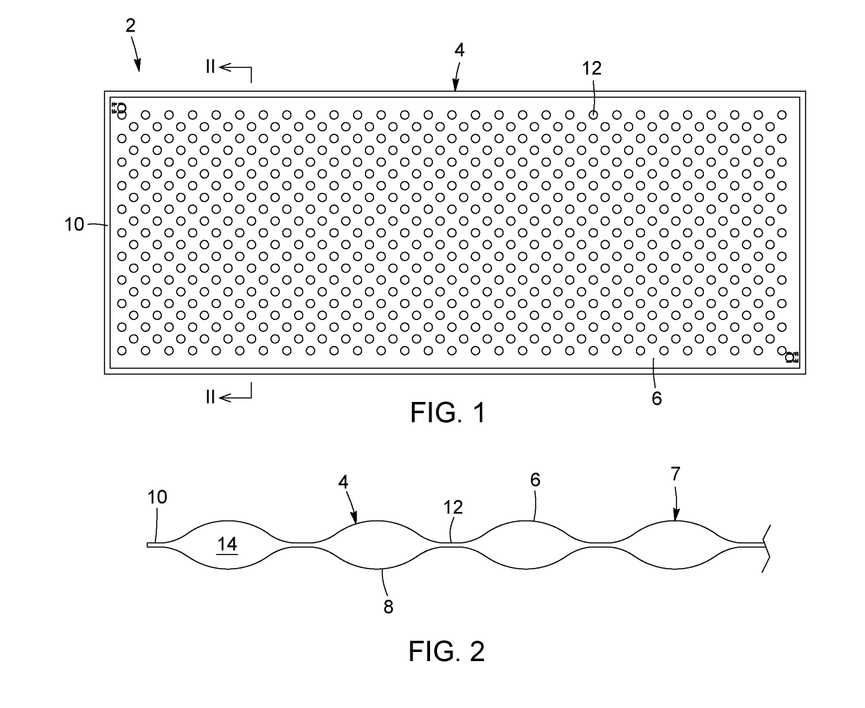

Referring to FIGS. 1 and 2, an embodiment of a solar thermal collector 2 for heating a fluid with absorbed solar thermal energy from solar radiations is shown.

The solar thermal collector 2 includes a solar absorber 4. The solar absorber 4 is embodied by a plurality of components assembled together for heating a fluid circulating in the solar absorber 4.

In the illustrated embodiment of FIG. 2, the solar absorber 4 includes an absorber plate 6 having an absorber plate perimeter 10 and an absorbing surface 7 which, when exposed to sunlight, can collect solar radiations and absorb it as thermal energy (or heat). As one skilled in the art will readily understand, the heat can then be transferred to a fluid circulating close to the absorbing surface 7 of the absorber plate 6 by thermal conduction. The absorber plate 6 can be made of a thermally stable heat conductive material. The thermally stable conductive material can include metals, such as stainless steel, galvanised steel, aluminum, copper, or brass. The absorber plate 6 can also be made of a polymeric material, or any monolithic sheet which is thermally stable and conducts heat.

The solar absorber 4 also includes a base plate 8, connected to the absorber plate 6 along the entire absorber plate perimeter so as to define a sealed cavity 14. In one embodiment, the absorber plate 6 and base plate 4 are connected through welding and the sealed cavity 14 therebetween is created by hydroforming, as further explained below. It will be readily understood that the sealed cavity 14 can receive a heat-transport fluid (not illustrated) to be heated by the thermal energy absorbed from the absorbing surface 7 of the absorber plate 6.

The base plate 8 can also be made of a thermally stable conductive material. The thermally stable conductive material can include metals, such as stainless steel, aluminum, copper, or brass. The base plate 8 can also be made of a polymeric material or any monolithic sheet which is thermally stable and conducts heat.

Optionally, the base plate may be made of the same material as the absorber plate.

In one example of implementation, the absorber plate 6 and the base plate 8 are made of stainless steel. Alternatively, one skilled in the art would readily know how to choose the material composing the absorber plate 6 and the material composing the base plate 8, which can be selected from the materials which have been previously listed or any other materials that are thermally stable, conductive and that can be welded together so as to form the sealed cavity 14.

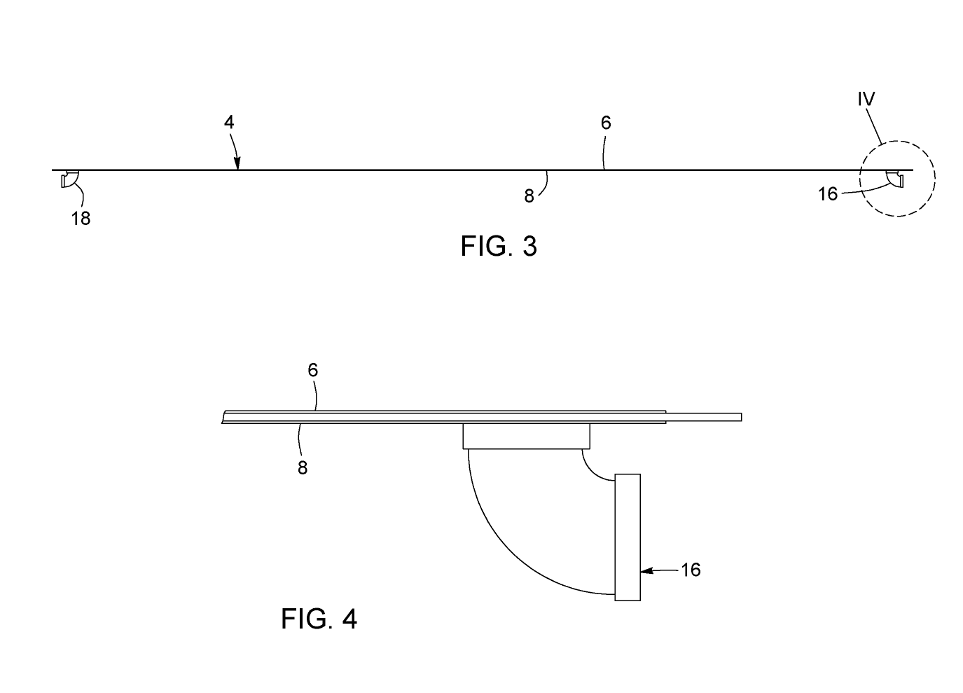

With reference to FIGS. 3 and 4, the solar thermal connector 2 also includes an inlet 16 configured to supply the fluid to be heated into the sealed cavity (not illustrated on FIGS. 3 and 4) between the absorber plate 6 and the base plate 8. The solar thermal connector 2 further includes an outlet 18 configured to evacuate the fluid from the sealed cavity after circulation and heating thereof. In the illustrated embodiments, each of the inlet 16 and outlet 18 is designed as a bent pipe mounted onto the base plate 8. It should be understood that the solar thermal collector 2 is not limited to include the illustrated type of bent pipes as inlet 16 and outlet 18. Optionally, the inlet 16 and/or outlet 18 can be mounted at various locations of the absorber plate 6 and/or the base plate 8, and can include various types of pipes and connections as known by one skilled in the art. For example, the inlet 16 and the outlet 18 can be mounted at diagonally opposed corners of the absorber plate 6 or base plate 8. Alternatively, the inlet 16 and the outlet 18 can be mounted on the absorber plate 6 and/or base plate 8 so as to be maximally spaced-apart. It will be understood that the inlet 16 and the outlet 18 may each be a monolithic element or embodied by a plurality of components assembled together aiming at supplying/evacuating the fluid to/out of the sealed cavity 14.

Referring back to FIGS. 1 and 2, the absorber plate 6 and the base plate 8 are further connected to each other at a plurality of contact points 12 distributed across opposed faces of the absorber plate 6 and the base plate 8. The distribution of the contact points 12 is chosen so as to create an array of junctures, thereby defining a fluid circulation path within the sealed cavity 14 for heating the heat-transport fluid (not illustrated in the Figures). By including an array of contact points 12 between the absorber plate 6 and the base plate 8, the solar thermal collector 2 benefits from an extended fluid circulation path within the sealed cavity 14 in comparison to known solar absorbers, without making use of any circulation pipes or additional devices. It will be readily understood that the expression “fluid circulation path” refers to the global network of pathways available across that sealed cavity, and that each individual droplets of the heat-transport fluid can follow any one of a great number of trajectories between the inlet and the outlet, such that the fluid flow substantially extends through the entire cavity and is therefore apt to extract thermal energy from substantially the entire absorbing surface. Furthermore, the use of contact points 12 is for example preferred to known collector structures involving fluid pipes as there is no pressure drop created within the system.

In some embodiments, the contact points 12 between the absorber plate 6 and the base plate 8 may be evenly distributed so as to form a regular array. Optionally, the number of the contact points may be selected according to the absorbing surface 7 of the absorber plate 6. For example, a ratio between the number of contact points and the absorbing surface 7 may range between 100 junctures/m² and 300 junctures/m².

Fluid pressure at the inlet 16 is preferably controlled upstream of the solar absorber 4 with pumps, valves and/or any other mechanical equipment that are known to one skilled in the art for regarding control of the fluid pressure. The solar absorber 4, and more particularly the sealed cavity 14, may advantageously be configured to resist fluid pressure ranging from 0 to 140 lbs, which is well above the gauge pressure in cities water (typically about 60 to 70 lbs). The fluid pressure at the inlet 16 is preferably chosen so as to optimize extraction of the thermal energy absorbed by the solar absorber 4.

In accordance with embodiments, a coating can cover at least partially the absorbing surface 7 of the absorber plate 6. Optionally, both absorber plate 6 and base plate 8 can be covered with a coating. The coating can be black paint or any specific coating improving absorption, retention and/or convection of thermal energy.

The heat-transport fluid may be selected in view of optimizing the absorption and transport of thermal energy. In accordance with embodiments, the heat-transport fluid may for example be a mixture of water and glycol, including between 50% and 70% of water and between 30% and 50% of glycol. Optionally, the heat-transport fluid may alternatively include water from various sources, chlorinated water, antifreeze chemicals, heat-conductive chemicals or a combination thereof. One skilled in the art would readily know how to choose the quantities of water and/or chemicals according to the solar thermal collector configuration.

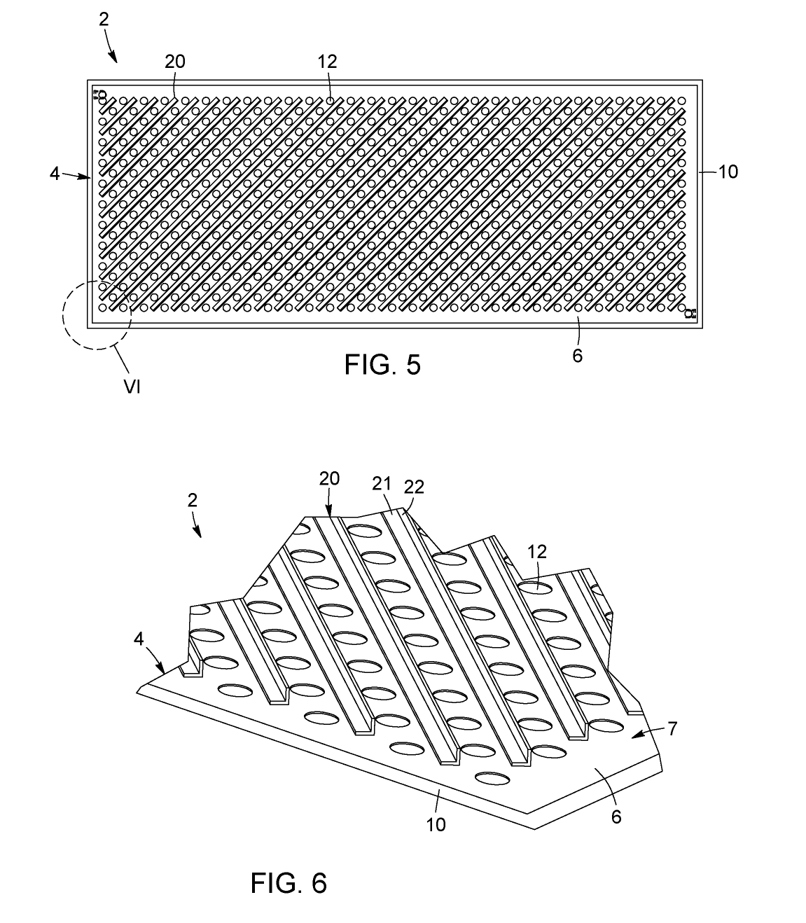

Referring now to FIGS. 5 and 6, in one embodiment the solar thermal collector 2 further comprises at least one absorbing protuberance 20 mounted to the absorber plate 6 surface. Each of the absorbing protuberance 20 can be made of a thermally stable conductive material. The thermally stable conductive material can include metals, such as stainless steel, aluminum, copper, or brass. Each of the absorbing protuberance 20 can also be made of a polymeric material. It will be understood that each of the absorbing protuberance 20 is a monolithic element or is embodied by a plurality of components which conjointly allows increasing the absorbing surface 7 of the absorber plate 6.

In the illustrated variant, the at least one absorbing protuberance 20 is a solar absorber component consisting of a longitudinal bar having an L-shaped cross-section. The longitudinal bar has a contact portion 21 and an absorbing portion 22 projecting from the contact portion 21 and extending outwardly from the absorber plate 6 so as to offer an extended absorbing surface 7 to solar radiations. The absorbing portion 22 is illustrated as projecting substantially perpendicularly from the contact portion 21, that is to say that an angle between the absorbing portion and the contact portion is about 90 degrees. It will be understood that the angle between the absorbing portion 22 and the contact portion may range between 0 and 90 degrees, or any angle allowing increasing the absorbing surface 7 of the absorber plate 6. Both the contact portion 21 and the absorbing portion 22 are made from a thermally stable heat conductive material, such as stainless steel, aluminum, copper, brass or polymeric material.

In some embodiments, the absorbing protuberance 20 may be made of a thermally conductive material which can be the same as the absorber plate 6 and/or the base plate 8. Alternatively, in other embodiments, the absorbing protuberance 20 can be made of a material which can be different than the material from which are made the absorber plate 6 and/or the base plate 8.

In the illustrated variant of FIGS. 5 and 6, the solar thermal collector 2 includes a plurality of longitudinal bars which are mounted and regularly spaced across the absorbing surface 7 of the absorber plate 6. It should be understood that the plurality of longitudinal bars may be mounted across the absorbing surface 7 according to various orientations, including diagonally such as illustrated on FIGS. 5 and 6, but also in many other directions along the absorber plate 6.

Depending on the geographic location for installation of the solar thermal collector 2, cold meteorological conditions can justify the use of heat-insulation for the solar thermal collector 2.

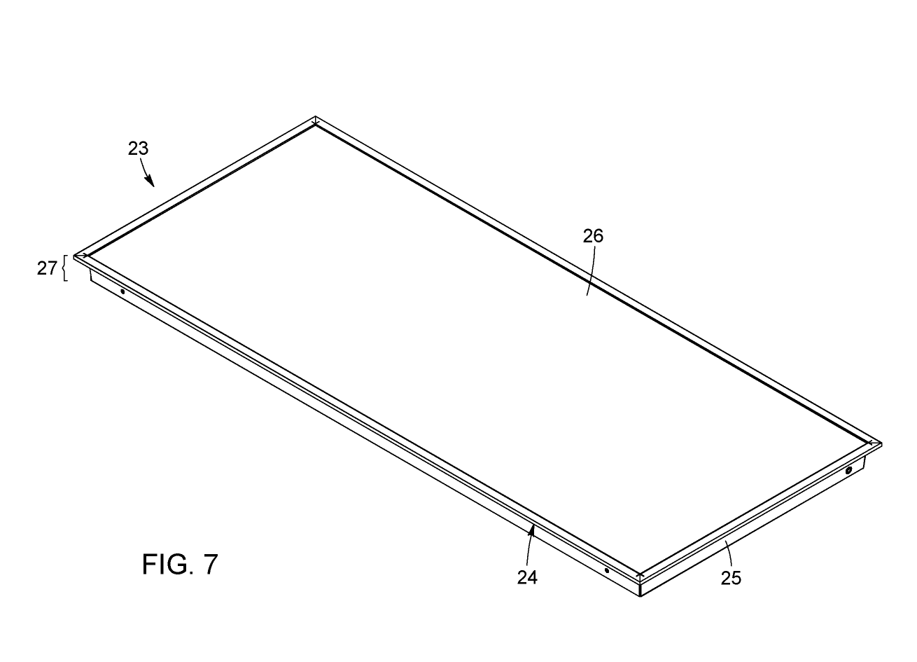

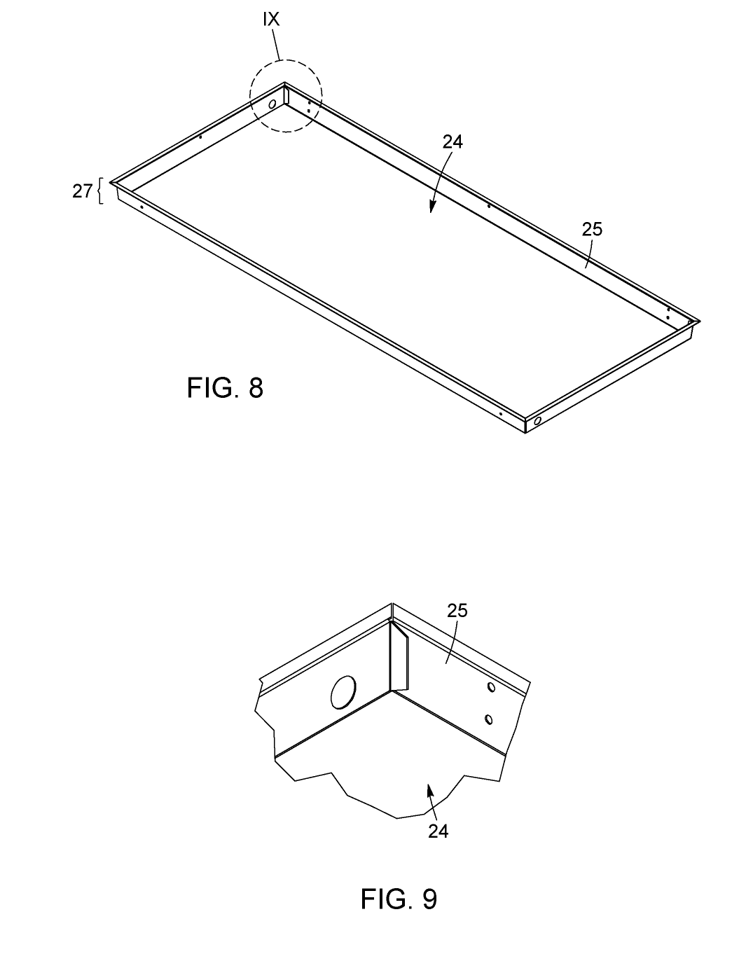

Referring to FIGS. 7 to 9, in accordance with one embodiment, there may be provided a solar thermal assembly 23 which includes a solar thermal collector 2 as defined above in combination with a heat-insulating casing 27.

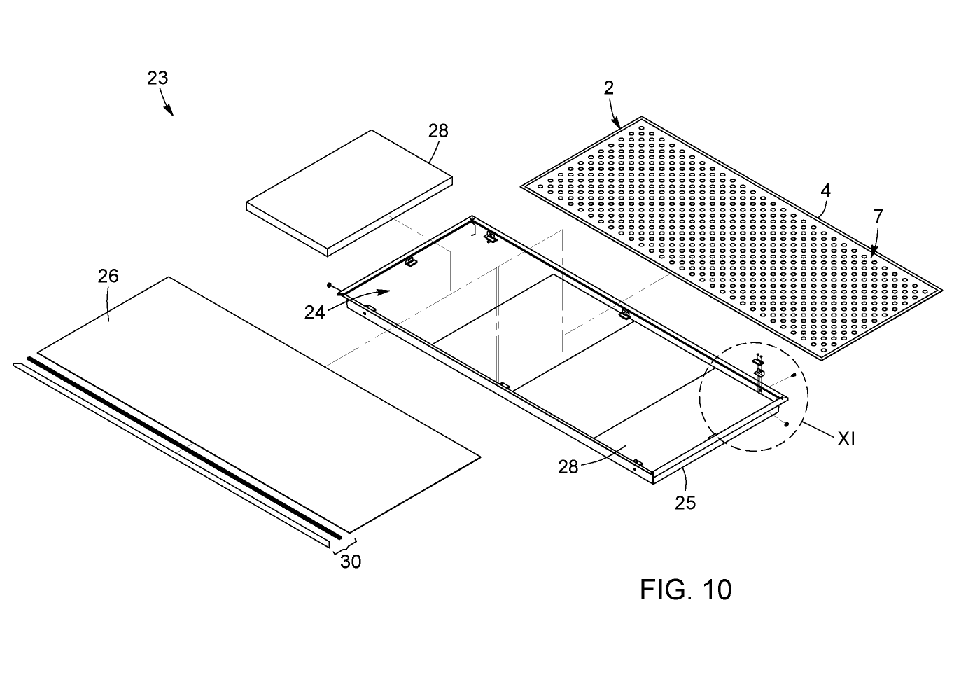

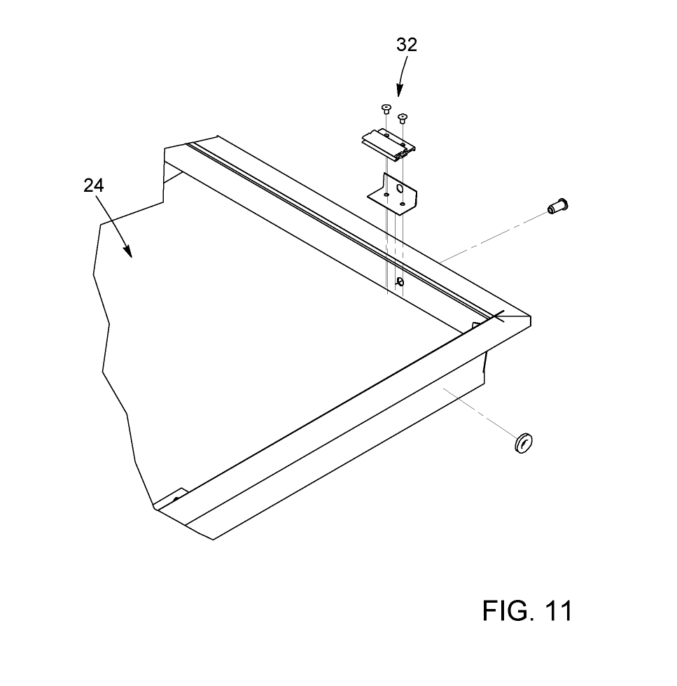

The heat-insulating casing 27 may generally include a casing base 24 having side walls 25, and a cover 26. The side walls 25 are mechanically connected to one another with bolts, screws, or any other elements allowing to mechanically joining the side walls 25 to one another. In embodiment illustrated in FIG. 9, the side walls 25 are connected to one another with clips.

Referring back to FIGS. 7 to 9, dimensions of the casing base 24 and side walls 25 are adapted to receive the solar absorber 4 as defined above (not illustrated on FIGS. 7 to 9).

In order to enable transmission of the solar radiations to the solar absorber 4, the cover 26, which is spaced-apart from the absorbing surface 7 of the collector, is made from an optically transparent material. The spectrum of electromagnetic radiations emanating from the sun and reaching the Earth (typically ranging from about 280 to 2500 nm) can be transmitted through the optically transparent material and subsequently be absorbed by the absorbing surface 7 of the absorber plate 6, located under the cover 26.

In some embodiment, the cover 26 can be made from a visually transparent material, such as solar glass, which is a translucent glass enabling 93.5% of the solar radiations spectrum to be transmitted to the absorbing surface 7 of the absorber plate 6.

Referring to FIGS. 10 and 11, the solar thermal collector assembly 23 includes the solar absorber 4 as defined above, the heat-insulating casing 27 including the casing base 24, the side walls 25 and the cover 26 which is mounted onto the casing base 24.

The cover 26 is mounted onto the casing base 24 with attachments 30. The attachments 30 may for example include grooves, extruded edges, bolts, screws, combination thereof, or any other elements allowing the cover to be attached to the casing base 24.

The solar thermal assembly 23 may also include one or more heat-insulating plate(s) 28. The heat-insulating plate(s) are generally disposed between the casing base 24 and the base plate 8 of the solar absorber 4 to improve heat insulation of the heat-insulating casing 27.

In some embodiments, the heat-insulating plate(s) 28 are made from a heat-insulating material, such as for example mineral wool, glass wool, fibreglass or cellulose.

Still referring to FIGS. 10 and 11, the solar absorber 4 may be mounted onto the casing base 24 with a plurality of fasteners 32, including rivets, fixing plates, extruded grooves, bolts, screws, combination thereof, or any other elements allowing the solar absorbed to be mounted onto the casing base 24. It will be understood that the various attachments and fasteners 30, 32 used to mount the solar absorber 4 and the cover 26 on the casing base 24 may vary from those illustrated on FIGS. 10 and 11.

In some embodiments, the heat insulating casing 27 may be used in conjunction with a solar thermal collector provided with the at least one absorbing protuberance 20 mounted on the absorbing surface 7 of the absorber plate 6. The geometry of the absorbing portion of the component may be selected so as to ensure that the cover 26 does not contact the absorbing portion of the component.

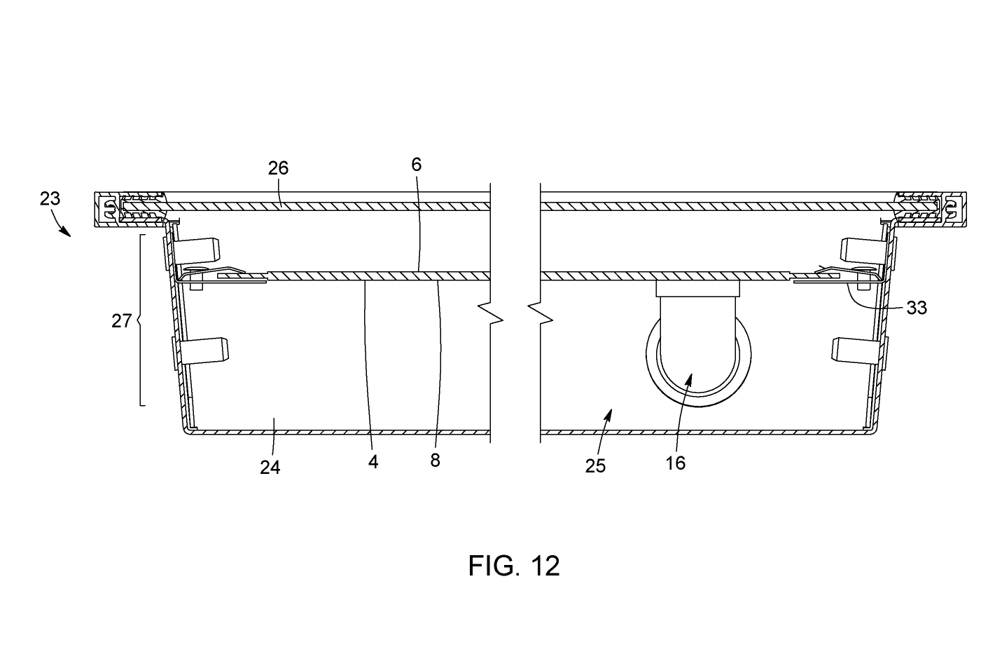

Now referring to FIG. 12 and in accordance with one embodiment, the solar thermal assembly 23 comprising the solar absorber 4, the cover 26 and the heat-insulating casing 27 is shown.

The solar absorber 4 is mounted to the heat-insulating casing 27 with the fasteners 32 and the cover 26 is mounted to the heat-insulating casing 27 with attachments 30 as defined above.

In the illustrated embodiment, the fasteners 32 are clamping fingers. It will be understood that the fasteners 32 can include grooves, extruded edges, bolts, screws, combination thereof, or any other elements allowing the solar absorber 4 to be attached to the heat-insulating casing 27.

The inlet 16 and the outlet (not shown on FIG. 12) are connected to the base plate 8.

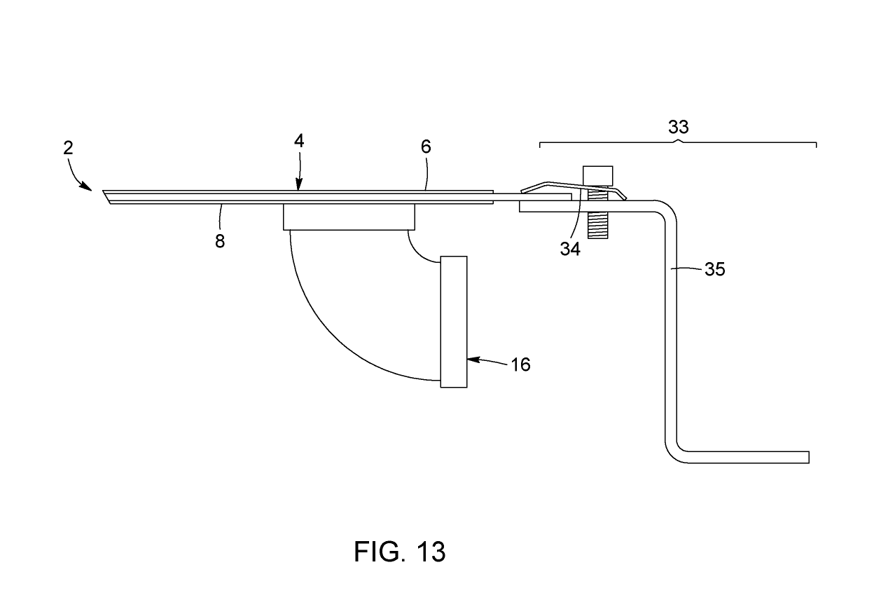

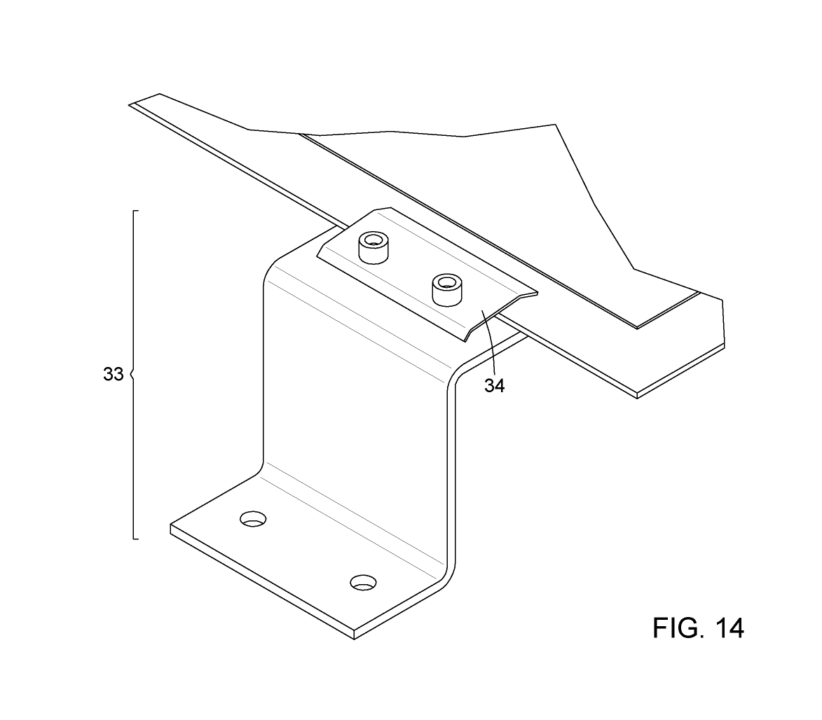

Now referring to FIGS. 13 and 14 and in accordance with one embodiment, the solar thermal collector 2 may be mounted onto a roof or a wall of a house with a support device 33.

The support device 33 may for example be embodied by a finger clamp 34 and an S-shaped brace 35. The finger clamp 34 is locked at one of its end with a screw or a bolt and has a projecting portion at another one of its extremity positioned to engage and squeeze the solar absorber 4. The S-shaped brace 35 is secured to the roof or wall with bolt, screw, combination thereof, or any other element allowing securing the Z-shaped brace 35 onto the roof or the wall. It will be understood that the S-shaped brace 35 may be a monolithic element or embodied by a plurality of components assembled together allowing mounting the solar thermal collector 2 on the roof or the wall of the house, and that its shape may differ from the one illustrated on FIGS. 13 and 14.

It should be understood that dimensions of the various parts of the solar thermal collector as illustrated in the Figures are purely illustrative and can vary according to the heating needs of the solar thermal collector 2, as will be known and chosen by the person skilled in the art.

Manufacture

The solar absorber 4 may be manufactured according to the following process steps, which avoids some known drawbacks such as deformation of pipes during hydroforming.

In some embodiments, the manufacture process includes a first peripheral connecting step to connect the absorber plate 6 to the base plate 8 along the perimeter 10 of the absorber plate, and a vacuum step to ensure that vacuum is made between the two connected plates. The first peripheral connection step between the absorber plate 6 and the base plate 8 along the perimeter 10 may be performed according to various methods, including laser welding or roll welding. In addition, the first peripheral connecting step may include sealing the perimeter of the connected plates with an adapted border. Optionally, the border can be made of aluminum.

In some embodiments, the manufacture process further includes a second connecting step to connect the absorber plate 6 to the base plate 8 at the plurality of contact points 12 defined above. For example, laser spot welding can be used to create round contact points distributed across the surface of the plates. The result obtained after performing the second connecting may include % inch-diameter contact points 12 spaced apart from one another by a distance of 3 inches.

In some embodiments, the manufacture process further includes a hydroforming step to shape the sealed cavity for receiving the fluid and create the fluid circulation path. The hydroforming step is performed according to the techniques known in the art, by injecting a hydraulic fluid under high pressure between the two connected plates 6, 8, to force the deformation of the ductile plates for a given time. The hydraulic fluid pressure may range between 400 psi and 600 psi for a forming time between 10 and 40 seconds. A press may be used to maintain the solar absorber with a plurality of bolts during hydroforming. It should be noted that other shapes of contact points may be used according to the configuration of the press during hydroforming.

The coating, such as black paint as previously described, may be sprayed, layered, painted or bonded to the absorbing surface 7 of the absorber plate 6 after the hydroforming step according to the means available to one skilled in the art. As already mentioned, the coating may also be applied to the base plate 8.

In some embodiments, the inlet 16 and the outlet 18 of the solar thermal collector 2 may be welded to the base plate 6 of the solar absorber 2 before the first peripheral connecting step of the process.

In other embodiments, the inlet 16 and/or outlet 18 can mounted at various locations of the absorber plate 6 and/or the base plate 8 before or after the first peripheral connecting step of the process.

It should further be understood that the various structural features of the solar thermal collector described herein for the purpose of fluid heating, can be applied to cooling a fluid, for example by putting the absorber in a cooled medium such as underground or in lake/river waters so as to continuously cool the fluid contained in the absorber. Of course, numerous modifications could be made to the embodiments described above without departing from the scope of the present invention.

1. A solar thermal collector for heating a fluid with absorbed solar thermal energy from solar radiations, the solar thermal collector comprising:
an inlet configured to supply the fluid into the solar thermal collector;
an outlet configured to evacuate the fluid from the solar thermal collector; and
a solar absorber having:
an absorber plate having an absorber plate perimeter and an absorbing surface, the absorbing surface being configured for absorbing the solar thermal energy from solar radiations; and
a base plate connected to the absorber plate along the entire absorber plate perimeter so as to define a sealed cavity therebetween, the base plate and absorber plate being further connected at a plurality of contact points distributed so as to create an array of junctures across the sealed cavity, thereby allowing the fluid to circulate throughout the sealed cavity when flowing from the inlet to the outlet.

2. The solar thermal collector according to claim 0, wherein the contact points are evenly distributed along the absorbing surface of the absorber plate.

3. The solar thermal collector according to claim 0, wherein the array of junctures defines a juncture density selected within a range between about 100 junctures/m² and 300 junctures/m².

4. A solar thermal collector according to claim 0, further comprising at least one absorbing protuberance mounted to the absorbing surface of the absorber plate.

5. A solar thermal collector according to claim 0, wherein each of the at least one absorbing protuberance consists of a longitudinal bar having an L-shaped cross-section and having a contact portion mounted on the absorber plate and projecting from the contact portion, the longitudinal bar extending outwardly from the absorber plate so as to offer an extended absorbing surface to solar radiations.

6. A solar thermal assembly comprising the solar thermal collector according to according to claim 0, and further comprises a heat-insulating casing enclosing the solar absorber, the heat-insulating casing having a cover made from an optically transparent material and spaced-apart from the absorber plate.

7. A solar thermal collector according to claim 0, wherein the inlet and the outlet are located at diagonally opposed corners of the base plate.

8. A solar thermal collector according to claim 0, wherein the inlet and the outlet are maximally spaced-apart.
